(19) United States
(12) Patent Application Publication
(10) Pub. No.: US 2023/0260491 A1
(43) Pub. Date: Aug. 17, 2023

(54) PERCUSSION INSTRUMENT MOTION REPRODUCTION DEVICE

(71) Applicant: YAMAHA CORPORATION, Hamamatsu-shi (JP)

(72) Inventors: Yoshiyuki TSUGE, Hamamatsu-shi (JP); Yoshihiro NAKAMURA, Hamamatsu-shi (JP); Yu SASAKI, Hamamatsu-shi (JP); Ryo HAMAOKA, Hamamatsu-shi (JP); Naoki TORIYAMA, Funabashi-shi (JP)

(21) Appl. No.: 18/305,836

(22) Filed: Apr. 24, 2023

Related U.S. Application Data
(63) Continuation of application No. PCT/JP2021/034643, filed on Sep. 21, 2021.

(30) Foreign Application Priority Data
Oct. 26, 2020 (JP) 2020-178742

(51) Int. Cl. G10H 3/14; G10D 13/063

(52) U.S. Cl. CPC G10H 3/14; G10D 13/063; G10H 2220/461

(57) ABSTRACT

A percussion instrument motion reproduction device includes a percussion instrument. The percussion instrument includes a vibration portion. The percussion instrument motion reproduction device includes a first driving portion. The first driving portion of the percussion instrument motion reproduction device is configured to visually displace the vibration portion in response to an electrical signal.

### CROSS-REFERENCE TO RELATED APPLICATIONS

This is a continuation of International Application No. PCT/JP2021/034643 filed on Sep. 21, 2021, and claims priority from Japanese Patent Application No. 2020-178742 filed on Oct. 26, 2020, the entire content of which is incorporated herein by reference.

### TECHNICAL FIELD

The present disclosure relates to a percussion instrument motion reproduction device for reproducing a motion of a percussion instrument during a performance.

### BACKGROUND ART

JP2019-028375A discloses a technique for reproducing a motion of a percussion instrument during a performance. In the technique disclosed in JP2019-028375A, automatic performance is performed by driving a stick of a drum based on music data and striking a drum head with the stick. In the technique disclosed in JP2019-028375A, it is possible to perform an automatic performance that appeals to audience by reproducing a motion of the stick during the performance.

### SUMMARY OF INVENTION

In a performance of a percussion instrument such as a cymbal, a motion of a portion to be struck (a vibration portion of the cymbal) by a stick serving as a striking member appeals to audience. However, technique for reproducing a motion of the vibration portion of the percussion instrument during a performance has not been provided.

The present disclosure has been made in view of the above circumstances, and an object thereof is to provide a percussion instrument motion reproduction device capable of reproducing a motion of a vibration portion of a percussion instrument during a performance.

The present disclosure provides a percussion instrument motion reproduction device including: a percussion instrument including a vibration portion; and a first driving portion configured to visually displace the vibration portion in response to an electrical signal.

### BRIEF DESCRIPTION OF DRAWINGS

The present disclosure will be described in detail based on the following figures, wherein:

FIG. 1 is a perspective view showing a configuration of a percussion instrument motion reproduction device according to an embodiment of the present disclosure;

FIG. 2 is a side view showing a state of a first driving portion when a cymbal is not swung in the percussion instrument motion reproduction device;

FIG. 3 is a side view showing a state of the first driving portion when the cymbal is swung in the percussion instrument motion reproduction device; and

FIG. 4 is a cross-sectional view showing a configuration of a second driving portion of the percussion instrument motion reproduction device.

### DESCRIPTION OF EMBODIMENTS

An embodiment of the present disclosure will be described below with reference to the drawings.

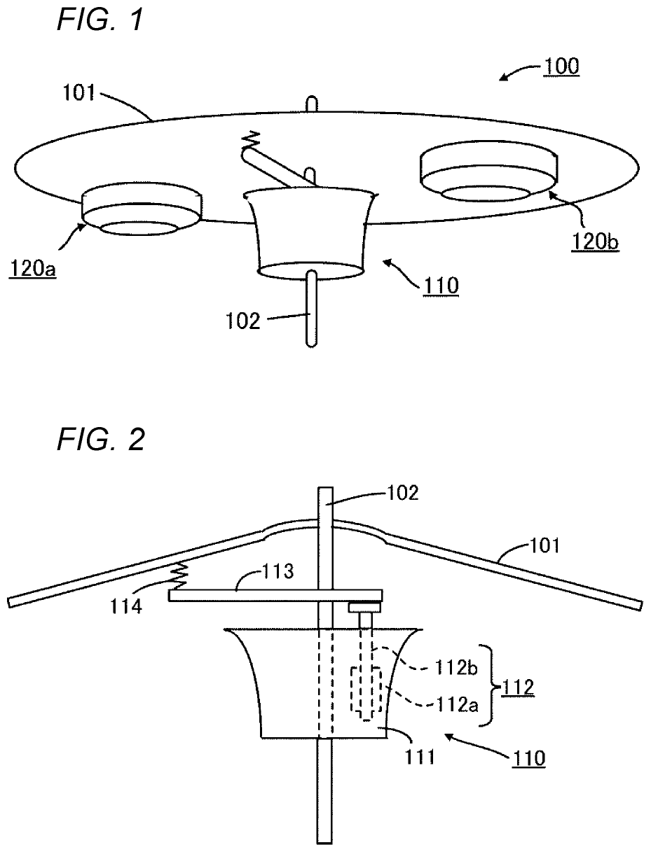

FIG. 1 is a perspective view showing a configuration of a percussion instrument motion reproduction device 100 according to an embodiment of the present disclosure as viewed obliquely from below. The percussion instrument motion reproduction device 100 includes a substantially circular plate-shaped cymbal 101 that is a percussion instrument, a shaft-shaped stand 102 that supports the cymbal 101 in a state of penetrating through the center of the cymbal 101, a first driving portion 110 fixed to the stand 102, and two second driving portions 120a and 120b attached to the cymbal 101.

The entire cymbal 101 forms a vibration portion. In a state where the cymbal 101 is supported by the stand 102, an upper surface of the cymbal 101 is a striking surface configured to be struck by a stick which is a striking member during a normal performance. During a normal performance, the cymbal 101 vibrates as the striking surface is struck, thereby emitting cymbal sound. Further, during the normal performance, when the striking surface is struck, the cymbal 101 swing about a support position on the stand 102.

The first driving portion 110 is a unit that visually displaces the cymbal 101 serving as a vibration portion in response to an electrical signal during an automatic performance. The term “visually displaces” means displacement such that it can be clearly seen by a naked eye that the cymbal 101 is moving. In other words, the first driving portion 110 may visibly moves the cymbal 101. Specifically, the first driving portion 110 according to the present embodiment swings the cymbal 101 around the support position on the stand 102 in response to an electrical signal. That is, the first driving portion 110 reproduces a motion of the cymbal 101 during a normal performance.

The two second driving portions 120a and 120b have the same configuration and weight, and vibrate the cymbal 101 serving as the vibration portion in response to an electrical signal the same as the electrical signal applied to the first driving portion 110, so that sound represented by the electrical signal is emitted. In a preferred aspect, the electrical signal is an electrical signal obtained by picking up, with a microphone, cymbal sound in a normal cymbal performance. In other words, the electrical signal is an electrical signal obtained by picking up, with a microphone, cymbal sound emitted when the striking surface of the cymbal 101 is struck with a stick which is a striking member.

In the present embodiment, the second driving portions 120a and 120b vibrate a position different from the position driven by the first driving portion 110, more specifically, a position away from the position driven by the first driving portion 110, in a surface of the cymbal 101 on a back side of the striking surface. This is because, at a position driven by the first driving portion 110 or a position close thereto, a drive force generated by the first driving portion 110 prevents the second driving portion 120a or 120b from vibrating the cymbal 101.

In the present embodiment, centers of the second driving portions 120a and 120b are respectively positioned at two points that are equidistant from the center on a diameter of the cymbal 101. Since the second driving portions 120a and 120b have the same moment of inertia around the support position on the stand 102, the cymbal 101 is kept horizontal in a state in which the cymbal 101 is not driven by the first driving portion 110.

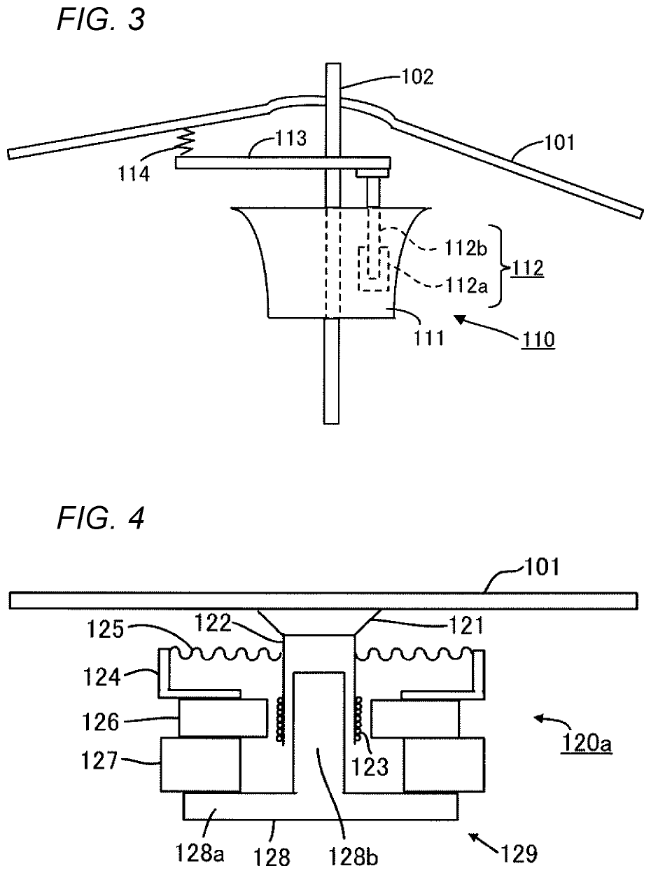

FIGS. 2 and 3 are side views of the first driving portion 110. More specifically, FIG. 2 shows the first driving portion 110 in a state in which the cymbal 101 is not swung, and FIG. 3 shows the first driving portion 110 in a state in which the cymbal 101 is swung.

As shown in FIG. 2 and FIG. 3, the first driving portion 110 includes a housing 111, a solenoid 112, a horizontal shaft 113, and a spring 114. The housing 111 is a member having a truncated cone shape. The stand 102 supports the housing 111 in a state of penetrating through the center of the housing 111. The solenoid 112 includes a coil 112a fixed to the inside of the housing 111, and a plunger 112b inserted through the coil 112a. The horizontal shaft 113 has a hole (not shown) through which the stand 102 is inserted at an intermediate position between both ends thereof. The horizontal shaft 113 is movable to carry out a parallel displacement in an upper-lower direction. A lower surface of one end of the horizontal shaft 113 is fixed to an upper end portion of the plunger 112b of the solenoid 112. The horizontal shaft 113 extends perpendicularly to the plunger 112b. An upper surface of the other end of the horizontal shaft 113 is connected to the surface of the cymbal 101 on the back side of the striking surface via the spring 114.

In the first driving portion 110, in a state in which the coil 112a of the solenoid 112 is not energized, the plunger 112b is not driven by the coil 112a, and the cymbal 101 is kept horizontal as shown in FIG. 2. On the other hand, in the first driving portion 110, in response to an electrical signal being applied to the coil 112a of the solenoid 112, the plunger 112b is lifted up by the coil 112a as shown in FIG. 3 so that movement of the plunger 112b is transmitted to the cymbal 101 via the horizontal shaft 113 and the spring 114, and the cymbal 101 swings.

In the present embodiment, a transmission characteristic of the first driving portion 110, that is, the transmission characteristic of a transmission system from an input portion of the coil 112a to the cymbal 101, has a pass band lower than a frequency band of the electrical signal (that is, the electrical signal representing the cymbal sound waveform) to be applied to the coil 112a. Therefore, the first driving portion 110 does not respond to each wave of the cymbal sound waveform represented by the electrical signal, and swings the cymbal 101 in response to the envelope of the cymbal sound waveform. That is, the first driving portion 110 swings the cymbal 101 in accordance with a sound emitting timing of the cymbal sound represented by the electrical signal.

FIG. 4 is a cross-sectional view showing a configuration of the second driving portion 120a. Although not shown, a configuration of the second driving portion 120b is the same as that of the second driving portion 120a.

In FIG. 4, a center portion 121 is fixed to the surface of the cymbal 101 on the back side of the striking surface. A hollow cylindrical portion 122 has an upper end portion fixed to a lower surface of the center portion 121 and extends downward from the center portion 121. A voice coil 123 is wound around a region near a lower end of the hollow cylindrical portion 122.

An outer side surface of the hollow cylindrical portion 122 is supported by an inner side surface of a dish-shaped housing 124 via an edge 125 which is an elastic member. A hole is formed in a bottom surface of the dish-shaped housing 124, and the hollow cylindrical portion 122 passes through the hole.

An annular first yoke 126 is fixed to a lower surface of the housing 124, and an annular magnet 127 is fixed to a lower surface of the first yoke 126. A hole is also opened in the center of each of the first yoke 126 and the magnet 127. The hollow cylindrical portion 123 passes through the hole provided in the first yoke 126 and reaches the inside of the hole of the magnet 127.

A second yoke 128 includes a circular plate portion 128a whose upper surface in an outer peripheral region of the circular plate portion 128a is fixed to a lower surface of the magnet 127, and a cylindrical portion 128b protruding upward at the center of the upper surface of the circular plate portion 128a. The cylindrical portion 128b of the second yoke 128 is inserted into a hollow region inside the hollow cylindrical portion 122.

The first yoke 126, the magnet 127, and the second yoke 128 constitute a magnetic circuit 129. In the magnetic circuit 129, a space between an inner side surface of the first yoke 126 and an outer side surface of the cylindrical portion 128b of the second yoke 128 defines a magnetic gap in which a magnetic field is generated by the magnet 127. The voice coil 123 is located in the magnetic gap.

In the above configuration, an electrical signal the same as the electrical signal applied to the first driving portion 110 is applied to the voice coil 123. When a current of a certain polarity flows through the voice coil 123 due to the electrical signal, for example, a force that pulls the cymbal 101 toward the second driving portion 120a is generated in the voice coil 123, and the cymbal 101 is displaced downward by this force. Further, when a current of a reverse polarity flows through the voice coil 123 due to the electrical signal, for example, a force that moves the cymbal 101 away from the second driving portion 120a is generated in the voice coil 123, and the cymbal 101 is displaced upward by this force. In the present embodiment, a transmission characteristic of the second driving portion 120a has a pass band that includes the frequency band of the electrical signal representing a performance sound waveform of the cymbal during a normal performance. Accordingly, the cymbal 101 vibrate up and down in accordance with each wave of the cymbal sound waveform represented by the electrical signal. Unlike the swing generated in the cymbal 101 by the first driving portion 110, the vibration generated in the cymbal 101 by the second driving portion 120a is a minute vibration that cannot be seen by a naked eye, and cymbal sound is emitted from the cymbal 101 due to the minute vibration. Similarly to the second driving portion 120a, the second driving portion 120b also vibrates the cymbal 101 according to an electrical signal.

As described above, in the present embodiment, the first driving portion 110 causes the cymbal 101, which is the vibration portion, to be visually displaced in response to an electrical signal. Specifically, the first driving portion 110 swings the cymbal 101 in response to the electrical signal. Thus, according to the present embodiment, it is possible to reproduce the motion of the vibration portion during a normal performance.

In addition, in the present embodiment, the second driving portion 120 vibrates the cymbal 101, which is the vibration portion, in response to an electrical signal and emit sound represented by the electrical signal. Thus, in the present embodiment, the cymbal 101 swings due to the vibration caused by the first driving portion 110, and vibrates due to the vibration caused by the second driving portions 120a and 120b, so as to emit cymbal sound. As described above, according to the present embodiment, in addition to the motion of the vibration portion during a normal performance, performance sound of the cymbal 101 during a normal performance can be reproduced.

Although one embodiment of the present disclosure has been described above, there may be other embodiments according to the present disclosure. For example, other embodiments may be as follows.

(1) In a case in which an electrical signal is read out from a storage medium and applied to the first driving portion 110, a mode of the readout control may be changed in accordance with a degree of movement of a cymbal sound waveform represented by the electrical signal (a degree of undulation of the envelope). Specifically, an electrical signal represented a small movement is read out from the storage medium at a normal reading speed and applied to the first driving portion 110. On the other hand, an electrical signal represented a large movement is read out from the storage medium in advance and applied to the first driving portion 110. For example, in a case in which an electrical signal represented a large movement is read out from the storage medium at a normal reading speed and applied to the first driving portion 110, a generation timing of a visual effect that the cymbal 101 swings is delayed with respect to a generation timing of an auditory effect that the cymbal sounds. According to this aspect, it is possible to compensate for the delay in the generation timing of such a visual effect.

(2) While an image of a scene of a musical instrument performance including a cymbal performance is reproduced on a screen, an electrical signal obtained by picking up cymbal performance sound with a microphone may be applied to the first driving portion 110 and the second driving portions 120a and 120b to perform automatic performance on the cymbal 101. According to this aspect, it is possible to increase the realism of the automatic performance.

(3) In the embodiment described above, the present disclosure is applied to a cymbal, but the present disclosure is not limited thereto. For example, the present disclosure may be applied to other musical instruments such as a triangle and a hand bell.

(4) In the embodiment described above, the cymbal 101 is supported by the stand 102 from below. Alternatively, the cymbal 101 may be played while suspended from above. In this case, for example, the first driving portion 110 may be provided on a member by which the cymbal 101 is suspended.

(5) In the embodiment described above, the percussion instrument motion reproduction device 100 includes the first driving portion 110 and the second driving portions 120a and 120b. Alternatively, the second driving portions 120a and 120b may not be provided in the percussion instrument motion reproduction device 100 since a motion of the cymbal 101 during a performance can be implemented by the first driving portion 110.

The present application is based on Japanese Patent Application No. 2020-178742 filed on Oct. 26, 2020, and the contents thereof are incorporated herein as reference.

According to the percussion instrument motion reproduction device of the present disclosure, it is possible to reproduce a motion of a vibration portion of a percussion instrument during a performance.

What is claimed is:

1. A percussion instrument motion reproduction device comprising:
a percussion instrument including a vibration portion; and
a first driving portion configured to visually displace the vibration portion in response to an electrical signal.

2. The percussion instrument motion reproduction device according to claim 1, wherein the first driving portion swings the vibration portion in response to the electrical signal.

3. The percussion instrument motion reproduction device according to claim 1, wherein:
the vibration portion has a striking surface configured to be struck by a striking member, and
the first driving portion drives a surface of the vibration portion on a back side of the striking surface.

4. The percussion instrument motion reproduction device according to claim 1, further comprising:
a stand supporting the percussion instrument,
wherein the first driving portion is fixed to the stand.

5. The percussion instrument motion reproduction device according to claim 1, wherein the first driving portion includes a solenoid.

6. The percussion instrument motion reproduction device according to claim 1, further comprising a second driving portion configured to vibrate the vibration portion in response to the electrical signal and emit sound represented by the electrical signal.

7. The percussion instrument motion reproduction device according to claim 6, wherein:
the vibration portion has a striking surface configured to be struck by a striking member,
the first driving portion drives a surface of the vibration portion on a back side of the striking surface, and
the second driving portion vibrates the surface on the back side at a position different from a position driven by the first driving portion.

8. The percussion instrument motion reproduction device according to claim 1, wherein the electrical signal is obtained by picking up striking sound of the percussion instrument.

9. The percussion instrument motion reproduction device according to claim 1, wherein a transmission characteristic of the first driving portion has a pass band lower than a frequency band of the electrical signal.

10. The percussion instrument motion reproduction device according to claim 5, wherein:
the vibration portion has a striking surface configured to be struck by a striking member,
the first driving portion further includes a horizontal shaft and a spring,
one end of the horizontal shaft is fixed to a plunger of the solenoid, and
another end of the horizontal shaft is connected to a surface of the vibration portion on a back side of the striking surface via the spring.

11. The percussion instrument motion reproduction device according to claim 10, wherein, in response to the electrical signal being applied to a coil of the solenoid in the first driving portion, the plunger is lifted up by the coil, where the lifting movement of the plunger transmits to the vibration portion, via the horizontal shaft and the spring, and swings the vibration portion.

12. The percussion instrument motion reproduction device according to claim 11, where the percussion instrument is a cymbal.
